(19) United States
(12) Patent Application Publication
(10) Pub. No.: US 2003/0217338 A1
(43) Pub. Date: Nov. 20, 2003

(54) Congestion mitigation with logic order preservation

(75) Inventors: Glenn E. Holmes, Wappingers Falls, NY (US); Zahi M. Kurzum, Poughkeepsie, NY (US); Shyam Ramji, Yorktown Heights, NY (US); Haoxing Ren, Wappingers Falls, NY (US); Paul G. Villarrubia, Austin, TX (US)

Correspondence Address: IBM MICROELECTRONICS, INTELLECTUAL PROPERTY LAW, 1000 RIVER STREET, 972 E, ESSEX JUNCTION, VT, 05452, US

(73) Assignee: International Business Machines Corporation, Armonk, NY

(21) Appl. No.: 10/063,837

(22) Filed: May 17, 2002

(51) Int. Cl. G06F 17/50

(52) U.S. Cl. 716/2

(57) ABSTRACT

A method, computer software, and system for performing congestion mitigation in an IC design while preserving global logic order, comprising the steps of carrying out circuit block placement; measuring the congestion for each circuit block to determine if it exceeds a target value; reallocating area to circuit blocks that exceed said target value of congestion solely from adjacent circuit blocks; and removing overlap.

### CROSS REFERENCE TO RELATED APPLICATIONS

Reference is made to co-pending U.S. patent application entitled, “Method and Systems for Placing Logic Nodes Based on An Estimated Wiring Congestion”, IBM Docket BUR920010145US1.

### BACKGROUND OF THE INVENTION

Technical Field

The present invention relates generally to integrated circuit design, and more specifically to automated placement of circuit blocks.

Design routing is a major issue in the modern ASIC placement design flow. By “placement,” we refer to the overall process by which area (“cells”) is allocated and assigned to the various macros, cores, and low level logic utilized in the design. By “routing,” we refer to that part of the placement process that locates the interconnect wiring that connects the various populated cells to one another, as well as wiring within a cell, to provide the requisite logic function. Design densities in deep submicron technologies are quite high, which results in major escalations in routing demands. Present day ASIC placement tools typically optimize placement for a particular, selected cost function, such as total wire length or net delay. Unfortunately, minimizing these cost functions for placement will not have a direct impact on routing, particularly local routing (that part of the overall routing process that focuses on interconnect placement within a cell or a small group of cells). This means that a placement optimized for a given cost function will have routing “hot spots,” or “congestion,” in which there are simply too many wires for the allocated space. Designers typically must enlarge their floorplans across the whole chip, which results in added expense and schedule delay.

Various congestion determination and relaxation techniques are known in the art. U.S. Pat. No. 6,068,662, “Method and Apparatus for Congestion Removal,” describes a process in which a design is analyzed for both horizontal and vertical congestion. If the congestion is horizontal, circuit blocks are relocated within given columns. If the congestion is vertical, circuit blocks are relocated to different columns. Horizontal and vertical congestion determination and block replacement is also discussed in U.S. Pat. No. 6,075,933, “Method and Apparatus for Continuous Column Density Optimization” and U.S. Pat. No. 6,123,736, “Method and Apparatus for Horizontal Congestion Removal.” U.S. Pat. No. 6,070,108, “Method and Apparatus for Congestion Driven Placement,” discloses a process in which after initial placement of the circuit blocks congestion is determined, and the circuit blocks are assigned general “fictive heights” for the purpose of going through multiple iterations of fictive replacement and congestive analysis to determine a placement that removes congestion.

In general, prior art congestion mitigation techniques are embedded into the placement flow (that is, after initial placement the congestion is mitigated and the circuits re-placed). Such integration presents several problems. First, doing congestion mitigation while running placement prevents an accurate estimation of congestion, because the detailed placement data is not generated until the placement algorithm is completely run. Second, constraints imposed by congestion mitigation are simply more constraints that the placement algorithm must adhere to; as such, performance of the final design may be compromised (e.g. timing constraints may not be completely realized). In other words, the congestion mitigation algorithm itself may degrade performance because it is running on incomplete data, and as such may lead to re-placements that penalize performance for the sake of congestion relief that may not have been ultimately required. As such, integrated placement and congestion tools do not optimize designs, because for the sake of congestion mitigation during placement cell blocks may be spaced more than absolutely necessary.

Accordingly, there is a need in the art for a congestion mitigation process that can run post-placement, and preserves the performance goals of the targeted design.

### BRIEF SUMMARY OF THE INVENTION

It is thus an object of the present invention to provide a congestion mitigation process that can run post-placement, while preserving the performance goals of the targeted design.

The foregoing and other objects of the invention are realized, in a first aspect, by a method for performing congestion mitigation in an IC design, comprising the steps of measuring the congestion in the IC design; and performing localized area reallocation from adjacent circuit blocks and linear overlap removal for those circuit blocks having congestion that exceeds a target value.

In another aspect, the invention comprises a computer-implemented method for performing congestion mitigation in an IC design while preserving global logic order, comprising the steps of carrying out circuit block placement; measuring the congestion for each circuit block to determine if it exceeds a target value; reallocating area to circuit blocks that exceed said target value of congestion solely from adjacent circuit blocks; and removing overlap.

In yet another aspect, the invention comprises a program storage device readable by a computer, tangibly embodying a program of instructions executable by the computer for performing congestion mitigation in an IC design while preserving global logic order, comprising the steps of carrying out circuit block placement; measuring the congestion for each circuit block to determine if it exceeds a target value; reallocating area to circuit blocks that exceed said target value of congestion solely from adjacent circuit blocks, and removing overlap.

### BRIEF DESCRIPTION OF THE SEVERAL VIEWS OF THE DRAWINGS

The foregoing and other features of the invention will become more apparent upon review of the detailed description of the invention as rendered below. In the description to follow, reference will be made to the several figures of the accompanying Drawing, in which:

FIG. 1 is a flowchart of the method of a first embodiment of the invention; and

FIG. 2 is a schematic diagram of computer software and computer hardware that embody a second embodiment of the present invention.

### DETAILED DESCRIPTION OF THE INVENTION

The present invention arises from the recognition that performance degradation resulting from congestion-driven re-placement primarily arises from logic reordering. The “order” of the logic refers to the desire for the circuits to be placed in accordance with the overall flow of the logic operations to be achieved by the design. Thus, for example if the design requires a NAND gate to receive an input from a NOR gate and provide an output to an XOR gate, it would be preferable for the NAND to be physically placed adjacent and between the NOR and the XOR, to optimize performance. Typically, congestion-driven re-placement results in logic reordering across the entire chip, as blocks get re-placed to circumvent congestion. While any congestion mitigation protocol (including that of the invention) could result in some timing delays from lengthening interconnects, the inventors have found that for many designs logic reordering inheirently degrades performance to a much greater extent.

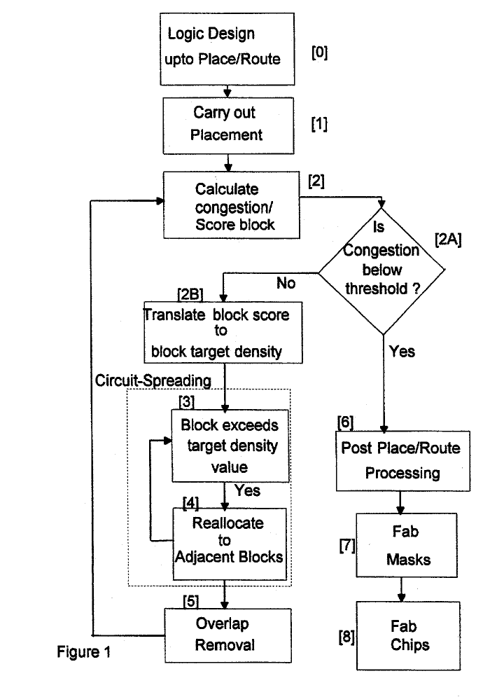

In the invention, as shown in FIG. 1, the logic design must first be processed up to placement and routing. As signified in block 0, the design must first go through all the conventional design steps leading up to placement and routing, including but not limited to entering said design in a technology-independent format and optimizing said entered design into a particular technology (the optimization process including optimizing said entered design for timing and insertion of test structures). Then, as shown in step 1, the design undergoes placement. Note that two possibilities exist for this placement step: (i) placement could be carried out without any contemporaneous congestion mitigation, or (ii) some degree of congestion mitigation could be included. The key point is that in the invention, reliance is not placed on the placement tool to carry out complete congestion mitigation. In alternative (ii) the placement tool is tuned to carry out “gross” congestion mitigation (e.g. mitigating the highest 50% of congestion during placement), with the “fine” congestion mitigation being carried out by the invention as described below (note, the relative percentage of congestion removed during placement could be anything above 0% and less than an amount that results in the performance degradations discussed above). Regardless of which alternative is used, placement is optimized for the chosen property (density, performance, cost, etc.) without added constraints imposed by carrying out complete congestion mitigation. In the present invention, alternative (ii) is preferred. Examples of placement software that would work here include the CPLACE program in IBM's EDA system, the placement software within the EDA tool “Silicon Ensemble” from Cadence Design Systems, and the “Blast Fusion” tool from Magma Design Automation Inc.

Then, at step 2 the design is analysed after full placement to determine absolute and relative congestion across the entire chip, at coordinates where circuit blocks are to be placed. That is, congestion is determined for each circuit block placement, and a congestion value is assigned for that block. Note that, as opposed to the prior art, the congestion calculation is carried out on fully-developed placement data. First, the global routing will be performed on the placement. There are many routing tools that can perform this task. In this invention we use the IBM Global Router. Then we collect all kinds of shapes that affect wiring demand and wiring supply. Those shapes including power routes, blockages, and global wires. The wiring supply on the edge of a circuit block can be determined by: Ws=number of layers*(edge length−blockage & power shapes cross the edge). The wiring demand on that edge can be determined by: Wd=global wire shapes cross the edge. The congestion on that edge can be determined by: Cedge=Wd/Ws. Finally, the congestion for the block can be determined by Cblock=(Cedge1+Cedge2+Cedge31+Cedge4)/4, where Cedge1, Cedge2, Cedge3 and Cedge4 are congestions values of the four edges of that block.

At step 2A, the calculated congestion for each circuit block is compared to the target value. Note that this target may be independently set at a higher value (to attenuate only peak congestion), or it may be set at a lower value (to minimize congestion beyond that absolutely necessary to wire up the design). If none of the blocks have congestion values that exceed the target value, then the design is ready for post placement and route processing (e.g. groundrule checking and shapes generation) per step 6.

At step 2B, the calculated congestion values are translated into a target density metric for each circuit block. The target density metric defines the extent to which each circuit block needs to be depopulated to reduce the wiring congestion below the target value. The iterative process of evaluating the current excess and reallocating the circuits to the neighboring circuit blocks is achieved in steps 3 and 4.

Then, in steps 3 and 4, the circuit block that has the higher congestion value is allocated enough extra space so that its congestion value falls below the target value. The allocated area is taken from adjacent circuit blocks with the lower calculated congestion. As such, the method of the invention converts a congestion problem into a circuit-spreading problem, whereby steps 3 and 4 are achieved through a single tightly coupled step. This operation is also referred to as “spreading.” For purposes of the invention, the objective of the algorithm is to do peak leveling. The spreading algorithm is modeled using a two-phase approach. The first phase models a network flow problem using bins (regions defined by some arbitrary superimposed grid on the given placement) and edges between neighboring bins. The capacity of the bins (defined by total real estate available), the size of the bins (total size of circuits/cells assigned to the bins), and the cost of moving the commodity (cells) between adjacent bins are determined for the flow-graph. The min-cost max-flow solution to this problem indicates the “global” desired movement of commodity (circuits/cells) between bins to satisfy the bin capacities. The second phase of the problem provides the flow between the bins by moving the desired flow amount (circuits/cells) determined in the first phase. The circuit (cell) selection process during spreading is based on minimum movement from the given initial placement. This is preferred for the present invention. Alternatively, the selection of the cells to be moved to adjacent blocks could be based on their timing criticality. The localized placement of cells within bins achieved through step 5 results in a final legal placement. The key feature of this technique is a two-dimensional approach to spread cells and the global nature of the formulation results in a “topology” aware spreading while keeping the movement of individual cells localized. This process results in all the blocks falling below the target congestion/density value, if there exists such a feasible solution, with overlapping cells within some circuit blocks. As a practical matter, space ends up being provided from empty blocks or underutilized blocks. Note the total reallocations across the total area of the chip exceed a threshold value (e.g. 10% of the total chip area), steps 2 and 2A are repeated to recalculate congestion. This is preferred for the present invention. Alternatively, congestion could be recalculated iteratively as each block is reallocated. As such, at those areas where spreading is high some logical reordering may occur; but because spreading is linear with congestion (i.e. the amount of spreading decreases in a linear fashion with decreasing congestion), the reordering is controlled to occur in a localized fashion. That is, the amount and degree of reordering happens only where it is required to reduce high congestion; as congestion decreases, so does reordering.

Finally, as shown in step S, the overall removal step eliminates circuit overlaps within each block. The free space within each block is distributed based on the pin count of the circuits (cells) to further facilitate the detailed wiring. The localized placement of circuits is achieved through a min-cut partitioning approach within the blocks by recursively dividing the region and assigning cells based on connectivity until the partitions are small enough compared to the cell sizes. This placement is performed at block level and hence still maintains the global relative ordering of the logic circuits while improving local wiring.

Upon completion of overlap elimination, the design is ready for post-placement and route processing (e.g. groundrule checking and shapes generation) per step 6.

The final output of step 6 is the final design data, which can be formatted in any one of a number of formats. It is preferred the design data be in an industry standard format such as GDSII. The data can be downloaded to a storage media such as tape or disc, and/or transmitted from the designer to the mask fabricator via the Internet. In step 7, the data is then used to fabricate photolithographic masks (that is, masks are made that embody the final design in the critical etch processes used to fabricate integrated circuit chips), and in step 8 the masks are used to fabricate integrated circuit chips, all pursuant to conventional techniques.

The invention can be utilized in conjunction with a variety of business models. One party (a design house) can carry out the base design (e.g. at least some of the steps in step 0), then provide the design to an ASICs design house that will map the base design into a given technology (which will typically include the place/route steps of the invention). The design house would then provide the final design from step 6 to the mask fabricator in step 7, who then provides those masks to the chip manufacturer in step 8. Some enterprises carry out all these steps in-house; in other scenarios, the base design comes from one company, the ASIC design/mapping from a second, the masks from a third, and the chip fabrication from a fourth. Obviously all sorts of permutations and combinations of the foregoing business models are possible.

The invention can be utilized in conjunction with a variety of business models. One party (a design house) can carry out the base design (e.g. at least some of the steps in step 0), then provide the design to an ASICs design house that will map the base design into a given technology (which will typically include the place/route steps of the invention). The design house would then provide the final design from step 6 to the mask fabricator in step 7, who then provides those masks to the chip manufacturer in step 8. Some enterprises carry out all these steps in-house; in other scenarios, the base design comes from one company, the ASIC design/mapping from a second, the masks from a third, and the chip fabrication from a fourth. Obviously all sorts of permutations and combinations of the foregoing business models are possible.

As previously stated, the iterative nature of the invention provides spreading while preserving logic order. A feature of the invention is that the either the reallocation (step 4) or the overlap removal (step 5) can be set to allow only a maximum amount of circuit movement before the process is stopped and the design is re-placed per step 1. That is, to the extent reordering does occur, the invention affords the designer an ability to prevent either (or both) reallocation or overlap from exceeding a value that would produce sufficient logical reordering to degrade performance, by assigning maximum values on a circuit block basis. For example, if a particular circuit block was in a critical timing path, the invention could be optimized to decrease the relative amount of permissive reallocation/spreading for that block (and related and/or adjacent blocks). Values could also be assigned based on the design choices made during placement—for example, if during placement the design was optimized for performance, values would be assigned to reflect that choice. Alternatively, values could be assigned based on different choices (placement optimized for performance, congestion mitigation optimized for cost). The inventors have found the invention results in preserving logic order, such that assigning these maximum values is not required; however, they may be useful for dealing with unique design requirements/constraints.

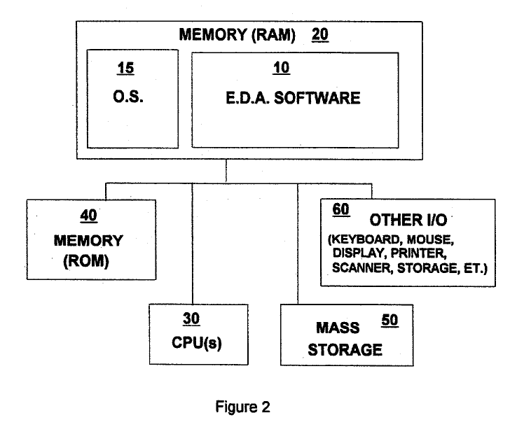

FIG. 2 illustrates a computer system that can be used to carry out the invention. The software of the invention would be included as part of the EDA SOFTWARE 10 at least partially resident (during execution) in RAM memory 20. The software, along with the computer's operating system O.S. 15, controls operation of the CPU(s) 30, which processes instructions based on the software and receives inputs from and providing outputs to MASS STORAGE 50, MEMORY 40, and OTHER I/O 60 (including but not limited to a display, such as a flat panel screen or a CRT). Another feature of the invention is that the results of each of the steps depicted in FIG. 1 can be displayed. In particular, the invention could be set up to provide color-coded indications of congestion as part of the output of step 2A in FIG. 1. Congestion density could be indicated with different colors on a plot of the chip, and congestion values that exceed the target limit could be indicated with a bold color (e.g. red). The shade of red could become darker as the congestion value more greatly exceeds the target value.

While the invention has been described above with reference to the preferred embodiments thereof, it is to be understood that the spirit and scope of the invention is not limited thereby. Rather, various modifications may be made to the invention as described above without departing from the overall scope of the invention as described above and as set forth in the several claims appended hereto.

What is claimed is:

1. A method for performing congestion mitigation in an IC design, comprising the steps of:
measuring the congestion in the IC design; and
performing localized area reallocation from adjacent circuit blocks and linear overlap removal for those portions of the IC design having congestion that exceeds a target value.

2. A method for performing congestion mitigation in an IC design, comprising the steps of:
carrying out circuit block placement;
measuring the congestion for each circuit block to determine if it exceeds a target value;
reallocating area to circuit blocks that exceed said target value of congestion solely from adjacent circuit blocks, and
removing overlap.

3. A computer-implemented method for performing congestion mitigation in an IC design while preserving global logic order, comprising the steps of:
carrying out circuit block placement;
measuring the congestion for each circuit block to determine if it exceeds a target value;
reallocating area to circuit blocks that exceed said target value of congestion solely from adjacent circuit blocks, and
removing overlap.

4. A program storage device readable by a computer, tangibly embodying a program of instructions executable by the computer for performing congestion mitigation in an IC design while preserving global logic order, comprising the steps of:
carrying out circuit block placement;
measuring the congestion for each circuit block to determine if it exceeds a target value;
reallocating area to circuit blocks that exceed said target value of congestion solely from adjacent circuit blocks, and
removing overlap.

5. The method of claim 2, wherein prior to said step of measuring the congestion in the IC design said method further comprises the steps of:
entering said design in a technology-independent format; and
optimizing said entered design into a particular technology.

6. The method of claim 5, wherein said step of optimizing said entered design further comprises the steps of:
optimizing said entered design for timing; and
insertion of test structures.

7. The method of claim 2, wherein said placement step is carried out without any contemporaneous congestion mitigation.

8. The method of claim 7, wherein said step of measuring the congestion for each circuit block indicates both absolute and relative congestion.

9. The method of claim 2, wherein said target value may be independently set at a value to minimize congestion beyond that absolutely necessary to wire up the design.

10. The method of claim 2, wherein said step of reallocating area to circuit blocks that exceed said target value comprises comparing congestion values for those circuit blocks having values that exceed said target value with congestion values for immediately adjacent circuit blocks.

11. The method of claim 10, wherein a circuit block that has the highest congestion value is allocated enough extra space so that its congestion value falls below the target value.

12. The method of claim 11, wherein said allocated space is taken from an adjacent circuit block with the lowest congestion value.

13. The method of claim 12, wherein said step of reallocating area to circuit blocks that exceed said target value is repeated until all of said circuit blocks with congestion values initially exceeding said target value are below said target value.

14. The method of claim 13, wherein space is allocated from empty blocks or underutilized blocks.

15. The method of claim 12, wherein said step of removing overlap comprises moving circuit blocks relative to one another to eliminate overlap.

16. The method of claim 15, wherein said step of removing overlap carries out peak leveling.

17. The method of claim 16, wherein said peak leveling comprises spreading out circuit blocks having a highest degree of overlap with adjacent blocks, then spreading out circuit blocks that have a next highest degree of overlap.

18. The method of claim 15, wherein an amount of overlap removal is linear with congestion.

19. The method of claim 3, further comprising the step of post-placement and route processing.

20. The method of claim 19, wherein said step of post-placement and route processing comprises the steps of groundrule checking and shapes generation.

21. The method of claim 19, further comprising the step of providing said design data to a manufacturer of photolithographic masks.

22. The method of claim 21, wherein said design data is provided in GDSII format.

23. The method of claim 21, further comprising the step of fabrication of photolithographic masks.

24. The method of claim 23, further comprising the step of fabrication of integrated circuit chips embodying said design.

25. The method of claim 1, wherein said localized area reallocation is set to allow only a maximum amount of reallocation before design re-placement.

26. The method of claim 1, wherein said linear overlap removal is set to allow only a maximum amount of reallocation before design re-placement.

27. The method of claim 3, wherein said step of measuring congestion further comprises displaying an indication of congestion for the entire design.
